(19) United States
(12) Patent Application Publication
(10) Pub. No.: US 2005/0068159 A1
(43) Pub. Date: Mar. 31, 2005

(54) Door lock apparatus for security identification using wireless communication device and method for the same

(76) Inventor: Chieh-Jung Hung, Chungho City (TW)

Correspondence Address: BIRCH STEWART KOLASCH & BIRCH, PO BOX 747, FALLS CHURCH, VA, 22040-0747, US

(21) Appl. No.: 10/899,090

(22) Filed: Jul. 27, 2004

(30) Foreign Application Priority Data
Sep. 26, 2003 (TW) 92126611

(51) Int. Cl. B60R 25/10

(52) U.S. Cl. 340/426.13

(57) ABSTRACT

A door lock apparatus and method for security identification by using a wireless communication device are proposed. Due to the uniqueness of the IMSI (International Mobile Subscriber Identification Number) contained in a SIM (Universal Subscriber Identity Module, USIM) card of a wireless communication device, such as cellular phone, the present invention uses a non-contact sensor to read the IMSI for security identification and thereby determine whether an electric lock should be locked or unlocked. Since the IMSI is unique for each wireless device, the security of the entrance control can be improved considerably. By this way, the wireless communication device can be applied to the identification mechanism of entrance locks, car's door locks or car's actuation.

### FIELD OF THE INVENTION

The present invention is directed to a door lock apparatus for security identification using a wireless communication device and method for the same, and more particularly, to a system and method that employs an non-contact sensor to read a unique International Mobile Subscriber Identification Number (IMSI) contained in the wireless communication device for identification.

### BACKGROUND OF THE INVENTION

Since public security is diminishing and the number of thieves increases daily, people often need to hire security guards and install anti-theft equipments or security systems to protect their lives and properties. However, the security equipments mainly serve as entrance guards and usually employ card-reading devices to identify house-owners by reading magnetic cards. The card-reading devices are connected to security hosts and employ these hosts to send messages to the control system of the security service firm via networks. Thereby, the security service firm can supervise people walking in and walking out.

However, the magnetic card has a magnetic plate attached thereon and the data stored in the magnetic plate are easily lost due to abrasion or demagnetization. As a result, data reading is hard or can't be performed. Hence, the magnetic card must often be repeatedly read, and the magnetic card must be often replaced. In addition, since the card-reading device is influenced easily by external interference signals, it may make the control of entrance security abnormal and impractical.

Furthermore, in general, when an applicant applies a communication service, a provider of a cellular phone system will offer the applicant with a universal subscriber identity module (SIM or USIM) card having an international mobile subscriber identification number (IMSI). The system provider only uses the IMSI number to identify whether the used SIM card is effective.

The IMSI number provided by the equipment manufacturer is a unique number for recognizing a mobile device. It is stored in an equipment identify register (EIR) of the SIM card. The IMSI is mainly composed of following portions:

1. Mobile country code (MCC), which includes three decimal numbers. For instance, the MCC is 460 for China, 262 for Germany and 466 for Taiwan.

2. Mobile network code (MNC), which includes two or three decimal numbers for recognizing the wireless communication network of the user. For instance, the Chunghwa Company is 092, TWN GSM 1800 is 097, Far East Tone is 091, TransAsia is 099 and KGT-ON LINE is 088.

3. Mobile subscriber number (MSN), which. includes ten or less decimal numbers for recognizing the user in the wireless communication network.

Consequently, how to develop a door lock apparatus and a method for security identification using a wireless communication device to overcome the shortcomings mentioned above so as to remove the drawbacks of the conventional magnetic cards used for entrance guards and reduce the usage of the magnetic cards in the security system is desired for people. For this reason, the inventor of the present invention sought diligently to improve the prior art according to his researches and practical development experiences of the products related to the wireless communication and finally developed the present invention successfully.

### SUMMARY OF THE INVENTION

An object of the present invention is to provide a door lock apparatus for security identification using a wireless communication device and method for the same. The present invention applies an IMSI of a wireless communication device for security identification. Since the IMSI for each cellular phone is unique and people use wireless communication devices extensively, applying the IMSI for security identification of the door lock can make the door lock securer.

Another object of the present invention is to provide a door lock apparatus, which is equipped with an input device, such as fingerprint input device, retina input device or keyboard input device, for security identification using a wireless communication device. The IMSI is used to perform the first security check while the input device is used to perform the second security check. Thereby, the present invention can make the door lock much securer.

For achieving the above objects, the present invention provides a door lock apparatus for security identification using a wireless communication device and a method for the same. Since the IMSI for each wireless communication device is unique, the electric door lock can use the non-contact sensor to identify user's IMSI and then performs a lock or unlock action according to the identification result. Since the IMSI for each wireless communication device is unique, the security mechanism of locks can be improved significantly. The present invention can be applied to entrance locks, locks of car doors or actuation of cars.

Moreover, since wireless communication devices, such as cellular phones, are used widely, in order to prevent the problem caused by loss of the devices, the prevent invention further provides an input device, such as fingerprint input device, retina input device, keyboard input device or their combinations, to perform the second security mechanism to make the locks much securer.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of a preferred embodiment in compliance with the prevent invention;

FIG. 2 is a block diagram of another preferred embodiment in compliance with the-prevent invention; and

FIG. 3 is an operative flow chart of a preferred embodiment in compliance with the present invention.

### DETAILED DESCRIPTION

Due to the uniqueness of the IMSI used on wireless communication devices, the present invention applies the same to entrance control. In order to further improve the security mechanism, the present invention can be combined with a password mechanism, or retina or fingerprint recognition. In the following, the cellular phone serves as an example of the wireless communication device in the prevent invention.

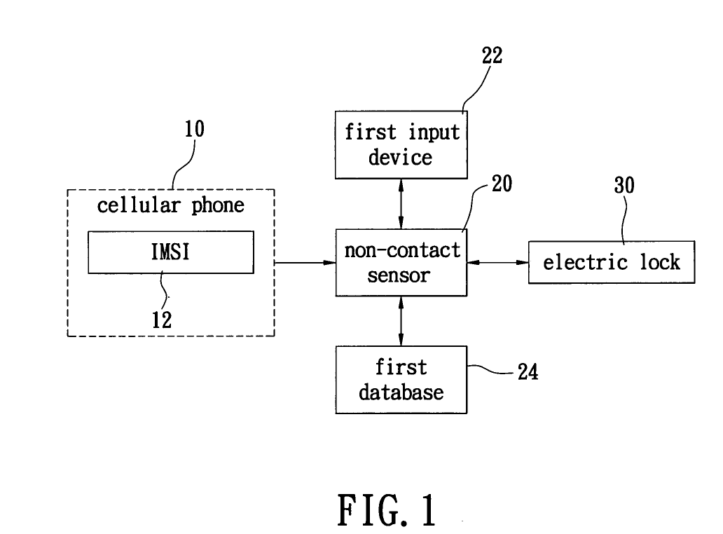

Reference is made to FIG. 1, which is a block diagram of a preferred embodiment in compliance with the prevent invention. In general, the cellular phone 10 includes a unique IMSI 12, which can be stored in a SIM card. The SIM card can be disposed in the cellular phone 10.

In the prevent invention, a non-contact sensor 20 is used to access the IMSI 12. Hence, a user only needs to make the cellular phone 10 close to the non-contact sensor 20. By this way, the prevent invention can access the IMSI 12 and identify whether the IMSI 12 is correct or not. When the identification process is finished, an electric lock 30 can perform a lock or unlock action according to the identification result.

The non-contact sensor 20 is connected with a first input device 22, a first database 24 and an electric lock 30. The first input device 22 is used to input the IMSI 12 and the first database 24 is used to pre-store the IMSI. After accessing user's IMSI 12, the non-contact sensor 20 will compare the same with the stored IMSI 12 to identify the identity of the user.

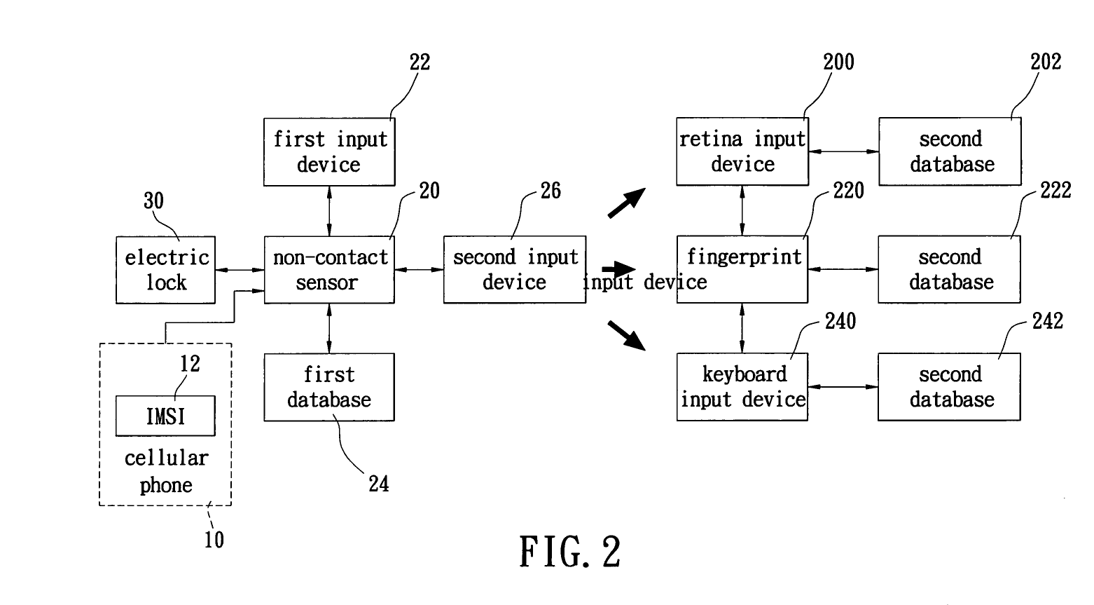

Reference is made to FIG. 2, which is a block diagram of another preferred embodiment in compliance with the prevent invention. Since the cellular phone 10 may be lost and will cause some unnecessary damage, the present invention further includes the second input device 26 as the second defense line. The second input device 26 is connected to the non-contact sensor 20 to perform the second protection mechanism via inputting a password.

The second input device 26 can be a retina input device 200. Hence, the password is retinal information and the non-contact sensor 20 further connects with the second database 202 to pre-store the retinal information. The second input device 26 can also be a fingerprint input device 220. Hence, the password is fingerprint information and the second database 222 is used to pre-store the fingerprint information. The second input device 26 can also be a keyboard input device 240. Hence, the password is a combination of numbers or characters and the second database 242 is used to store the information of the number or character combination.

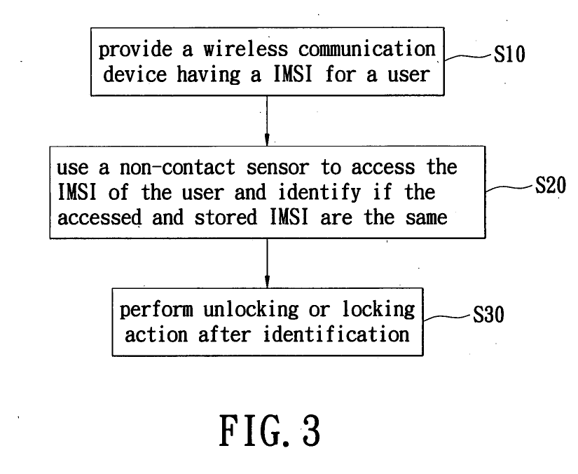

Finally, reference is made to FIG. 3, which is an operative flow chart of a preferred embodiment in compliance with the present invention. The method of the present invention for security identification of a door lock by using a wireless communication device includes the steps as follows:

Step 10: provide a wireless communication, such as the cellular phone 10, which have the IMSI 12 for a user;

Step 20: use the non-contact sensor 20 to access the IMSI 12 of the user and identify whether the accessed and stored IMSIs are the same or not; and

Step 30: unlock or lock the electric lock 30 after identification.

The present invention employs the unique IMSI 12 of the cellular phone 10 to control the electric lock so as to perform a security check. Further, since the cellular phone 10 is used universally, the present invention is more usable. For instance, the present invention can be applied to a dock lock or a car lock as a security device, and can even be used to actuate car's engine. If the cellular phone 10 is lost, the present invention can use the second input device 26 as the second defense line. The second input device 26 can be a fingerprint input device 220, retina input device 200 or keyboard input device 240. This second protection mechanism makes the present invention much securer.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A method for security identification of a door lock using a wireless communication device, the method comprising:
providing the wireless communication device, which includes an international mobile subscriber identification number (IMSI);
accessing the IMSI;
identifying the accessed IMSI; and
unlocking or locking an electric lock after identification.

2. The method as claimed in claim 1, wherein the wireless communication device is a cellular phone.

3. The method as claimed in claim 1, wherein the IMSI is stored in a universal subscriber identity module (SIM) card disposed in the wireless communication device.

4. The method as claimed in claim 1, wherein the step of accessing the IMSI is performed via using a non-contact sensor.

5. The method as claimed in claim 1, wherein the step of identifying the accessed IMSI is performed by determining whether the accessed IMSI and a stored IMSI are identical.

6. The method as claimed in claim 1 further comprising the following steps after the step of identifying the accessed IMSI is performed:
inputting at least a password; and
comparing the password with a stored user password.

7. The method as claimed in claim 6, wherein the step of inputting the password is performed by scanning a retina.

8. The method as claimed in claim 6, wherein the step of inputting the password is performed by scanning a fingerprint.

9. A apparatus for security identification of a door lock using a wireless communication device,-the apparatus comprising:
a wireless communication device having a first IMSI;
a first database used to pre-store at least a second IMSI;
a non-contact sensor having a data sensing module used to access the IMSI; and
an electric lock connected with the non-contact sensor, the electric lock using the non-contact sensor to identify whether the first IMSI is identical to the second IMSI and then unlocking or locking according to the identification result.

10. The apparatus as claimed in claim 9, wherein the wireless communication device is a cellular phone.

11. The apparatus as claimed in claim 9, wherein the IMSI is stored in a SIM card and the SIM card is disposed in the wireless communication device.

12. The apparatus as claimed in claim 9, wherein the non-contact sensor comprises:
an input device connected with the electric lock for inputting at least a first-password, the input device being capable of comparing the password with a second password to perform a second security check.

13. The apparatus as claimed in claim 12, wherein the non-contact sensor comprises:
a second database used to pre-store the second password.

14. The apparatus as claimed in claim 12, wherein the input device is a retina input device and the first password is retinal data.

15. The apparatus as claimed in claim 12, wherein the input device is a fingerprint input device and the first password is fingerprint data.

16. The apparatus as claimed in claim 12, wherein the input device is a keyboard input device and the first password is a number password or a character password.
